(19) United States
(12) Patent Application Publication
(10) Pub. No.: US 2014/0200289 A1
(43) Pub. Date: Jul. 17, 2014

(54) ORGANIC MONTMORILLONITE ENHANCED EPOXY RESIN AND PREPARATION METHOD THEREOF

(71) Applicants: Quanta Computer Inc., Taoyuan Shien (TW); Tech-Front (Shanghai) Computer Co., Ltd., Shanghai (CN)

(72) Inventors: Xin WANG, Shanghai (CN); Jin-Chang Wu, New Taipei City (TW); Wen-bing Wang, Shanghai (CN)

(21) Appl. No.: 13/909,716

(22) Filed: Jun. 4, 2013

(30) Foreign Application Priority Data
Jan. 11, 2013 (CN) 201310011105.2

(51) Int. Cl. C08K 5/19

(52) U.S. Cl. CPC C08K 5/19
USPC 523/461

(57) ABSTRACT

An organic montmorillonite enhanced epoxy resin and a preparation method thereof are provided. The preparation method of the organic montmorillonite enhanced epoxy resin includes adding an organic montmorillonite exfolicated by an organic solvent and a coupling agent to increase the thermal stability and reliability of the epoxy resin.

### CROSS-REFERENCE TO RELATED APPLICATION

This application claims the priority benefit of China application serial no. 201310011105.2, filed Jan. 11, 2013, the full disclosure of which is incorporated herein by reference.

### BACKGROUND

1. Technical Field

The disclosure relates to an epoxy resin. More particularly, the disclosure relates to an epoxy resin with an inorganic filler.

2. Description of Related Art

The most commonly used material for the substrate of printed Circuit Board (PCB) is epoxy resin. Traditionally, dicyandiamide (DICY) is the commonly used curing agent of the epoxy resin. The pyrolysis temperature of halogen epoxy resin cured by dicyandiamide is about 320° C. But after surface-mount technology (SMT) began to be lead-free, the melting temperature of the solder is increased from about 180° C. to about 220° C. Therefore, the heat resistance of the dicyandiamide cured halogen epoxy resin is insufficient, and the PCB delamination at 260° C. is thus shorten to about 10 minutes. Moreover, the PCB substrate can be damaged in a rework process with an even higher temperature.

The requirement of the Association Connecting Electronics Industries (IPC) for PCB made by lead-free process is that the PCB delamination time has to be longer than 15 minutes, and the pyrolysis temperature has to be higher than 325° C. In order to meet the IPC's standards, the substrate material is cured by phenolic novolac (PN) to cure the epoxy resin. In addition, 20-50 wt % of inorganic fillers are added to meet the fire prevention effect. However, the inorganic fillers increase the abrasion of drill pins to decrease the usable times of the drill pins from 2500 times to 1500 times. Hence, the production cost of PCB is increased.

### SUMMARY

In one aspect, the present invention is directed to a method of preparing an organic montmorillonite enhanced epoxy resin to make the substrate of printed circuit board meet the unleaded surface-mount technology. The preparing method of the organic montmorillonite enhanced epoxy resin was described below.

A first dispersion solution is prepared by dispersing 100 parts by weight of an epoxy resin in a first organic solvent. A second dispersion solution is prepared by dispersing 1-5 parts by weight of an organic montmorillonite in a second organic solvent. A third dispersion solution is formed by sequentially adding 3-9 parts by weight of a curing agent and 1-5 parts by weight of a coupling agent into the second dispersion solution and mixing them uniformly. A fourth dispersion solution is formed by uniformly mixing the first dispersion solution and the third dispersion solution. An epoxy resin mixture is formed by removing the first and the second organic solvents of the fourth dispersion solution. The organic montmorillonite enhanced epoxy resin is formed by crosslinking the epoxy resin mixture.

According to an embodiment, the epoxy resin is bisphenol A glycidyl ether epoxy resin, flame retardant bisphenol A epoxy resin, or polyphenol glycidyl ether epoxy resin.

According to another embodiment, the first or the second organic solvent is acetone, dimethyl formamide, toluene, xylene, methyl ethyl ketone, ethanol, butyl glycidyl ether, or any combinations thereof.

According to yet another embodiment, an intercalating agent between inorganic layers of the organic montmorillonite comprises an alkyl trimethyl ammonium bromide, and the alkyl group of the alkyl trimethyl ammonium bromide has 12-18 carbons.

According to yet another embodiment, the curing agent is heating type or room temperature type. The heating type curing agent comprises dicyandiamide. The room temperature curing agent comprises a modified amine curing agent, such as phenol sulfonic acid, or a product of the addition reaction of diethylenetriamine and epoxypropane butyl ether.

According to yet another embodiment, the coupling agent comprises a silane-based coupling agent, such as γ-(2,3-epoxy propoxy) propyl trimethoxy silane, γ-aminopropyl triethoxy silane, γ-(methyl-acryloyl oxy) propyl trimethoxy silane, vinyl triethylalkoxy silane, vinyl trimethoxy silane, or vinyl tris(β-methoxyethoxy) silane.

According to yet another embodiment, an accelerant is further added into the second dispersion solution after adding the coupling agent when the crossliker is a heating type curing agent.

According to yet another embodiment, the coupling agent can be added to the first dispersion solution instead when the curing agent is room temperature type.

In another aspect, an organic montmorillonite enhanced epoxy resin is provided. The organic montmorillonite enhanced epoxy resin is prepared by the method above.

The forgoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later. Many of the attendant features will be more readily appreciated as the same becomes better understood by reference to the following detailed description considered in connection with the accompanying drawings.

### BRIEF DESCRIPTION OF THE DRAWINGS

FIG. 1 is a process flow diagram of preparing an organic montmorillonite enhanced epoxy resin according to an embodiment of this invention.

FIGS. 2A and 2B are process flow diagrams of preparing an organic montmorillonite enhanced epoxy resin according to another embodiment of this invention.

FIG. 3A shows the thermal gravimetric analysis (TGA) curve of example 10.

FIG. 3B shows the TGA curves of example 10 (solid line) and example 11 (dashed line) thermostat at 260° C. for 1 hour.

FIG. 4A shows thermomechanical analysis (TMA) curves of the epoxy glass fiber substrates of example 10 respectively at 260° C. and 288° C., and FIG. 4B shows TMA curves of the epoxy glass fiber substrates of example 11 at 260° C.

FIG. 5 is a scanning electron microscopic (SEM) photograph of the example 10's substrate after 1 hour at 288° C.

### DETAILED DESCRIPTION

Accordingly, a method of preparing an organic montmorillonite enhanced epoxy resin is provided. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### Preparation Method of Organic Montmorillonite Enhanced Epoxy Resin

In one aspect, this invention provides a method of preparing an organic montmorillonite enhanced epoxy resin.

Organic montmorillonite (OMMT) is a peelable nano material for strengthening organic materials. The addition of exfolicated organic montmorillonite into an organic material can increase the strength and toughness of the organic material. The peeling methods of an organic montmorillonite can be a high temperature peeling method, a solvent peeling method, or a mechanical peeking method (the organic montmorillonite is exfolicated by a high speed mixer).

Since acetone is commonly used for dissolving epoxy resin to prepare the PCB's substrate, solvent is normally left over. Therefore, if the high temperature peeling method is used to exfolicate the organic montmorillonite, the dangers of solvent evaporation and firing are often occurred to decrease the heat resistance temperature of the epoxy resin. If the mechanical peeling method is used to exfolicate the organic montmorillonite, specialized equipments such as a twin-screw extruder are needed. Therefore, the organic montmorillonite was exfolicated by the solvent peeling method in the peeling method below. That is, the organic montmorillonite was dispersed in an organic solvent to be peeled.

### Using Heating Type Curing Agent

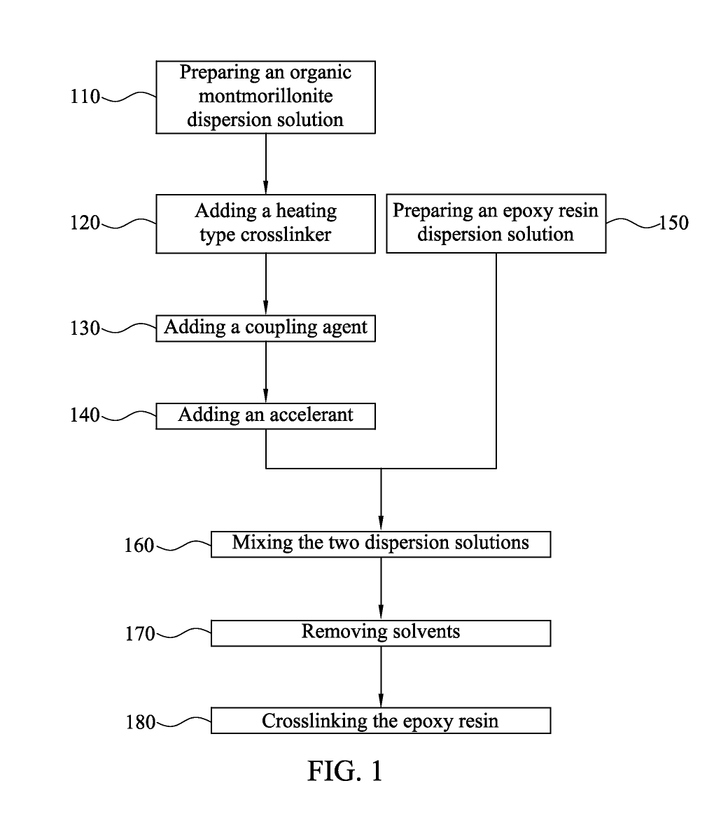

According to an embodiment, when a heating type curing agent is used to crosslink the epoxy resin, the preparation process is shown in FIG. 1.

In FIG. 1, an organic montmorillonite dispersion solution is prepared first in step 110. Then, a heating type curing agent (step 120), a coupling agent (step 130), and an accelerant (step 140) are sequentially added into the dispersion solution of the organic montmorillonite. After sufficiently stirring, the above described components are well dispersed in the dispersion solution of the organic montmorillonite as nano-particles. On the other hand, an epoxy resin dispersion solution is also prepared in step 150. Then, the dispersion solutions of steps 140 and 150 are sufficiently mixed in step 160. After removing the solvents of the mixing dispersion solution in step 170, the obtained mixture is heated to crosslink the epoxy resin to obtain an organic montmorillonite enhanced epoxy resin in step 180. The details of the each step above are described below.

In step 110, the organic montmorillonite dispersion solution is prepared by the following method. In the beginning, an inorganic montmorillonite is uniformly dispersed in water and swelled to obtain the inorganic montmorillonite dispersion solution having a concentration smaller than 90 w/v %. The inorganic montmorillonite can be sodium montmorillonite or potassium montmorillonite, and the cation exchange capacity (CEC) of the inorganic montmorillonite is 70-100 mmol/100 g.

Next, an intercalating agent is dispersed in water to form an intercalating agent aqueous solution. The intercalating agent can be an alkyl trimethyl ammonium bromide, and the alkyl group of the alkyl trimethyl ammonium bromide has 12-18 carbons, such as dodecyl trimethyl ammonium bromide (DTAB), hexadecyl trimethyl ammonium bromide (CTAB), or trimethylstearylammonium bromide (STAB). The weight ratio of the intercalating agent over the inorganic montmorillonite is about 0.5-0.7.

Then, the inorganic montmorillonite dispersion solution and the intercalating agent aqueous solution can be uniformly mixed by stirring, ultrasonication, or both, and then dried to obtain dried organic montmorillonite.

Finally, 1-5 parts by weight of the dried organic montmorillonite is re-dispersed in a first organic solvent. After uniformly stirring, an organic montmorillonite dispersion solution is obtained, and the organic montmorillonite is dispersed therein in nano scale. The first organic solvent can be a commonly used solvent for diluting resin. For example, the first organic solvent can be acetone, dimethyl formamide, toluene, xylene, methyl ethyl ketone, ethanol, butyl glycidyl ether, or any combinations thereof.

In step 120, a heating type curing agent is added into the organic montmorillonite dispersion solution of step 110 and sufficiently stirred. The heating type curing agent is used to crosslink the epoxy resin to cure the epoxy resin. The heating type curing agent can be dicyandiamide. The used amount of the heating type curing agent can be about 3-9 parts by weight.

In step 130, a coupling agent is added into the organic montmorillonite dispersion solution of step 120 and sufficiently stirred. The coupling agent is used as a bridge to couple the inorganic layers of the organic montmorillonite and the epoxy resin to increase the bonding strength between the organic montmorillonite and the epoxy resin. The used amount of the coupling agent is about 1-5 parts by weight.

The coupling agent can be a silane-based coupling agent, such as γ-(2,3-epoxy propoxy) propyl trimethoxy silane, γ-aminopropyl triethoxy silane, γ-(methyl-acryloyl oxy) propyl trimethoxy silane, vinyl triethylalkoxy silane, vinyl trimethoxy silane, or vinyl tris(β-methoxyethoxy) silane. After partially hydrolyzing the above silane-based coupling agents, a terminal of the silane-based coupling agents can generate a silanol group, which can form a covalent bond with the inorganic layers of the organic montmorillonite. Organic functional groups of the silane-based coupling agents can crosslink with the epoxy resin. Therefore, the inorganic layers of the organic montmorillonite and the epoxy resin can be bonded together by the silane-based coupling agent via multiple chemical bonds.

The coupling agent also can be a titanate (Ti(OR)₄) coupling agent, such as Ti(OBu)₄, Ti(iPr)₄, or other available titanates. The alkoxy group (—OR) of the titanates can be exchanged with —COOH group (trace amount) or —OH group on the surfaces of the inorganic layers of the organic montmorillonite to form Ti—O chemical bonds between the titanates and the inorganic layers of the organic montmorillonite. In addition, the alkyl part of the alkoxy groups of the titanates also can interwine with the molecular chains of the epoxy resin to bind with the epoxy resin. Therefore, the inorganic layers of the organic montmorillonite and the epoxy resin can be bound together by the titanate coupling agent. Moreover, various reactive functional groups can also be introduced into the alkoxy group of the titanates to increase the coupling interaction between the inorganic layers of the organic montmorillonite and the epoxy resin.

If the particle size of the added inorganic filler is in the micrometer range, the needed amount of the coupling agent is about 0.1-1 wt % of the inorganic filler to prevent producing the problem of agglomeration settlement when the inorganic filler is added too much. However, if the particle size of the added inorganic filler is in the nanometer range, the used amount of the inorganic filler can be substantially increased to 20-100 wt % since the nano inorganic filler has huge surface area. Therefore, huge number of covalent bonds can be formed between the organic montmorillonite and the epoxy resin to form a complex organic-inorganic cured network architecture, and the heat resistance of the epoxy resin can be greatly improved.

In step 140, an accelerant is added into the organic montmorillonite dispersion solution of step 130 and sufficiently stirred. Thus, each components mentioned above can be uniformly mixed and dispersed in nanoscale in the organic montmorillonite dispersion solution. The accelerant added here is used to accelerate the crosslinking reaction of the epoxy resin to cure the epoxy resin. The role of the accelerant includes decrease the needed reaction temperature and reaction time by the crosslinking reaction. The accelerant can be 2,4,6-tris(dimethylaminomethyl)phenol, 2-ethyl-4-methyl imidazole or m-phenylenediamine, for example.

In step 150, an epoxy resin dispersion solution is additionally prepared by dispersing an epoxy resin in a second organic solvent. The used amount of the epoxy resin is about 100 parts by weight. The epoxy value, which is the molar number of epoxy group per 100 g epoxy resin, can be 0.025-0.57, such as 0.44-0.54. The epoxy resin can be bisphenol A glycidyl ether epoxy resin, flame retardant bisphenol A epoxy resin, or polyphenol glycidyl ether epoxy resin, for example. The second organic solvent can be acetone, dimethyl formamide, toluene, xylene, methyl ethyl ketone, ethanol, butyl glycidyl ether, or any combinations thereof, for example.

In step 160, the dispersion solutions of steps 140 and 150 are mixed together to form a mixed dispersion solution.

In step 170, the first and the second solvents in the mixed dispersion solution is removed. The solvent removal method can be heating, for example. The heating temperature has to be lower than the reaction temperature of the heating type curing agent and the coupling agent. For example, the heating temperature can be 100° C.

In step 180, the epoxy resin is cured to cure the epoxy resin. Since the curing agent is heating type, the epoxy resin can be cured by heating the mixture of step 170 to a temperature above the crosslinking reaction temperature to perform the crosslinking reaction. Taking the dicyandiamide crosslinking agent as an example, the mixture of step 170 can be heater at 130° C. for 2 hours, and then heated at 150° C. for 2 hours, to complete the crosslinking reaction of the epoxy resin

### Using Room Temperature Type Curing Agent

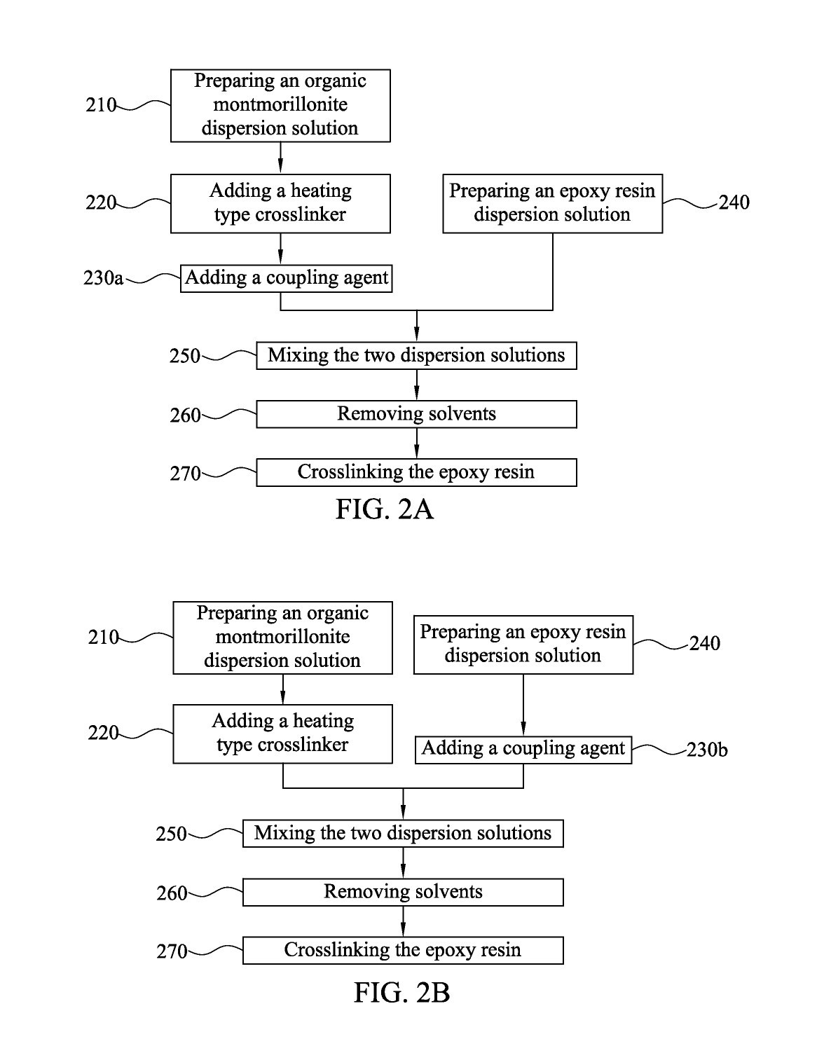

According to another embodiment, when a room temperature type curing agent is used to crosslink the epoxy resin, the preparation process is shown in FIG. 2A or FIG. 2B. Comparing with the heating type curing agent above, since a room temperature type curing agent is used here and the reaction temperature thereof is different from the reaction temperature of the heating type curing agent, the preparation method needs some adjustments. Since the reactivity of the room temperature curing agent is better, accelerant is no more needed. The room temperature type curing agent can be a modified amine curing agent, such as phenol sulfonic acid, or a product of the addition reaction of diethylenetriamine and epoxypropane butyl ether.

Furthermore, the coupling agent can be added into the organic montmorillonite dispersion solution after the room temperature type curing agent as in FIG. 1, or can be added into the epoxy resin dispersion solution. The details will be explained in the related illustrations of FIGS. 2A and 2B.

In FIG. 2A, an organic montmorillonite dispersion solution is prepared first in step 210. Then, a room temperature type curing agent (step 220) and a coupling agent (step 230a) are sequentially added into the organic montmorillonite dispersion solution and sufficiently stirred to uniformly and disperse in nanoscale each component in the organic montmorillonite dispersion solution. On the other hand, an epoxy resin dispersion solution is also prepared in step 240. Subsequently, the dispersion solutions of steps 230a and 240 are sufficiently mixed in step 250. At last, the epoxy resin is cured at room temperature to obtain an organic montmorillonite enhanced epoxy resin in step 260. In addition, the epoxy resin can be optionally heated at 50° C. for 1-2 hours to be cured more completely.

The only difference between the process flows of FIGS. 2A and 2B is the addition way of the coupling agent. In step 230a of FIG. 2A, the coupling agent is added into the organic montmorillonite dispersion solution. In step 230b of FIG. 2B, the coupling agent is added into the epoxy resin dispersion solution. Since the rest parts of the process flow in FIG. 2B is the same as the process flow in FIG. 2A, the detailed description is omitted here.

### Organic Montmorillonite Enhanced Epoxy Resin

In another aspect, an organic montmorillonite enhanced epoxy resin prepared by the method above is provided. The composition for preparing the organic montmorillonite enhanced epoxy resin comprise 100 parts by weight of an epoxy resin, 1-5 parts by weight of an organic montmorillonite, 3-9 parts by weight of a curing agent, 1-5 parts by weight of a coupling agent. Optionally, 0.2-0.6 parts by weight of accelerant is further needed when the curing agent is heating type to accelerate the crosslinking reaction of the epoxy resin.

### Embodiment 1

### Effect of Preparation Composition to Pyrolysis Temperature

In this embodiment, organic montmorillonite enhanced epoxy resins were prepared by following the process flow of FIG. 1. The epoxy resin E44 was dispersed in a mixed solvent of acetone and dimethyl formamide. Finally, the solvents of the mixed dispersion solution were removed at 100° C. The crosslinking reaction of the epoxy resin was performed at 130° C. for 2 hours, and then at 150° C. for 2 hours. The relative addition amount of each component to the epoxy resin and the pyrolyesis temperature of each example are listed in Table 1 below.

The pyrolysis temperature of the epoxy resin E44 without adding the organic montmorillonite was 320° C. Accordingly, most pyrolysis temperatures of examples 1-10 were 30-50° C. higher than the pyrolysis temperature of the epoxy resin E44. Comparing with some present techniques, such as that disclosed in the specification of CN 1250064. In CN 1250064, the pyrolysis temperature of the epoxy resin cured by N-dimethyl benzyl amine (BDMA) was 386° C. to 403° C. by adding an organic montmorillonite. The pyrolysis temperature was increased by only 17° C. Therefore, it can be known that the pyrolysis temperature increased by 30-50° C. in the examples of this invention was astonishing.

TABLE 1
Addition amount of each component and pyrolysis temperatures
are listed. The listed weight percent of each component was based on the
weight of the epoxy resin.

| | | ²organic | ³curing | | | ⁶pyrolysis |
|---|---|---|---|---|---|---|
| | ¹Epoxy | montmorillonite | agent | ⁴coupling | ⁵accelerant | temperature |
| Examples | resin | (wt %) | (wt %) | agent (wt %) | (wt %) | (° C.) |
| 1 | E44 | 1 | 1 | 4 | 0.2 | 363 |
| 2 | E44 | 1 | 3 | 5 | 0.4 | 348 |
| 3 | E44 | 1 | 5 | 6 | 0.6 | 345 |
| 4 | E44 | 3 | 1 | 5 | 0.6 | 346 |
| 5 | E44 | 3 | 3 | 6 | 0.2 | 352 |
| 6 | E44 | 3 | 5 | 4 | 0.4 | 357 |
| 7 | E44 | 5 | 1 | 6 | 0.4 | 322 |
| 8 | E44 | 5 | 3 | 4 | 0.6 | 345 |
| 9 | E44 | 5 | 5 | 5 | 0.2 | 359 |
| 10 | E44 | 3 | 3 | 4 | 0.2 | 370 |

¹E44 was a bisphenol A glycidyl ether epoxy resin, and the epoxy value was 0.44.
²The intercalation agent of the organic montmorillonite was hexadecyl trimethyl ammonium bromide (CTAB).
³The curing agent was a dicyandiamide.
⁴The coupling agent was γ-(2,3-epoxy propoxy) propyl trimethoxy silane.
⁵The accelerant was 2,4,6-tris (dimethylaminomethyl) phenol.
⁶Samples was heated under high purity nitrogen atmosphere, and the heating rate was 10° C./minute. The listed temperature was the temperature of about 5 wt % weight loss.

### Embodiment 2

### Effect of Organic Montmorillonite to Pyrolysis Temperatures of Various Epoxy Resins

In this embodiment, organic montmorillonite enhanced epoxy resins were prepared by following the process flow of FIG. 1, and three types of epoxy resins were used to compare the pyrolysis temperatures under the same addition amount of the curing agent, the coupling agent, and the accelerant. The obtained results are listed in Table 2 below. From Table 2, it can be known that the pyrolysis temperatures of each epoxy resin were all increased. Especially the E44 epoxy resin, the pyrolysis temperature was increased by 40° C.

TABLE 2
Effect of organic montmorillonite to pyrolysis temperatures of
various epoxy resins. The listed weight percent of each component was based
on the weight of the epoxy resin.

| | | ²organic | ³curing | | | ⁶pyrolysis |
|---|---|---|---|---|---|---|
| | ¹Epoxy | montmorillonite | agent | ⁴coupling | ⁵accelerant | temperature |
| Examples | resin | (wt %) | (wt %) | agent (wt %) | (wt %) | (° C.) |
| 11 | E44 | 0 | 3 | 4 | 0.2 | 330 |
| 10 | E44 | 3 | 3 | 4 | 0.2 | 370 |
| 12 | E51 | 0 | 3 | 4 | 0.2 | 345 |
| 13 | E51 | 3 | 3 | 4 | 0.2 | 361 |
| 14 | 6001 | 0 | 5 | 4 | 0.2 | 299 |
| 15 | 6001 | 3 | 5 | 4 | 0.2 | 324 |

¹All epoxy resins used here were bisphenol A glycidyl ether epoxy resins. The epoxy value of both E44 and 6001 was 0.44, and the epoxy resin of E51 was 0.51. The epoxy resin 6001 was added with a flame retarder, Al(OH)₃.
E44 was a, and the was 0.44.
²The intercalation agent of the organic montmorillonite was hexadecyl trimethyl ammonium bromide (CTAB).
³The curing agent was a dicyandiamide.
⁴The coupling agent was γ-(2,3-epoxy propoxy) propyl trimethoxy silane.
⁵The accelerant was 2,4,6-tris (dimethylaminomethyl) phenol.
⁶Samples was heated under high purity nitrogen atmosphere, and the heating rate was 10° C./minute. The listed temperature was the temperature of about 5 wt % weight loss.

### Embodiment 3

### Effect of Accelerant to Pyrolysis Temperature

In this embodiment, organic montmorillonite enhanced epoxy resins were prepared by following the process flow of FIG. 1. The preparation conditions of the example 10 and 16 were all the same, except the accelerant. In example 10, the accelerant was 2,4,6-tris(dimethylaminomethyl)phenol. In example 16, the accelerant was 2-ethyl-4-methyl imidazole. The obtained pyrolysis temperatures are listed in Table 3 below. From Table 3, it can be known that the type of the accelerant has a considerable influence on the pyrolysis temperature. The pyrolysis temperature was increased by the curing agent of 2,4,6-tris(dimethylaminomethyl)phenol in example 10, and the pyrolysis temperature was decreased by the curing agent of 2-ethyl-4-methyl imidazole in example 16.

TABLE 3
Effect of accelenant to pyrolysis temperature. The listed weight
percent of each component was based on the weight of the epoxy resin.

| | | ²organic | ³curing | | | ⁶pyrolysis |
|---|---|---|---|---|---|---|
| | ¹Epoxy | montmorillonite | agent | ⁴coupling | ⁵accelerant | temperature |
| Examples | resin | (wt %) | (wt %) | agent(wt %) | (wt %) | (° C.) |
| 10 | ¹E44 | 3 | 3 | 4 | ^{5a}0.2 | 370 |
| 16 | E44 | 3 | 3 | 4 | ^{5b}0.2 | 307 |

¹E44 was a bisphenol A glycidyl ether epoxy resin, and the epoxy value was 0.44.
²The intercalation agent of the organic montmorillonite was hexadecyl trimethyl ammonium bromide (CTAB).
³The curing agent was a dicyandiamide.
⁴The coupling agent was γ-(2,3-epoxy propoxy) propyl trimethoxy silane.
^{5a}The accelerant was 2,4,6-tris (dimethylaminomethyl) phenol.
^{5a}The accelerant was 2-ethyl-4-methyl imidazole.
⁶Samples was heated under high purity nitrogen atmosphere, and the heating rate was 10° C./minute. The listed temperature was the temperature of about 5 wt % weight loss.

### Embodiment 4

### Effect of Coupling Agent to Pyrolysis Temperature

In this embodiment, organic montmorillonite enhanced epoxy resins were prepared by following the process flow of FIG. 1, and various coupling agents were used to see the effect of the coupling agents to the pyrolysis temperatures. In example 10, the coupling agent was γ-(2,3-epoxy propoxy) propyl trimethoxy silane. In example 18, the coupling agent was γ-aminopropyl triethoxy silane. In example 19, the coupling agent was Ti(OBu)₄. The obtained pyrolysis temperatures are listed in Table 4 below. The pyrolysis temperatures were increased by silane-based coupling agent in examples 10 and 1. However, the pyrolysis temperature was decreased by the Ti(OBu)₄ coupling agent in example 19. This may due to the different interaction ways of silane-based coupling agent and titanate coupling agent.

TABLE 4
The effect of the coupling agent to the pyrolysis temperature.
The listed weight percent of each component was based on the weight of the
epoxy resin.

| | | ²organic | ³curing | | | ⁶pyrolysis |
|---|---|---|---|---|---|---|
| | ¹Epoxy | montmorillonite | agent | coupling | ⁵accelerant | temperature |
| Examples | resin | (wt %) | (wt %) | agent(wt %) | (wt %) | (° C.) |
| 10 | ¹E44 | 3 | 3 | ^{4a}4 | 0.2 | 370 |
| 18 | E44 | 3 | 3 | ^{4b}4 | 0.2 | 350 |
| 19 | E44 | 3 | 3 | ^{4c}4 | 0.2 | 300 |

¹E44 was a bisphenol A glycidyl ether epoxy resin, and the epoxy value was 0.44.
²The intercalation agent of the organic montmorillonite was hexadecyl trimethyl ammonium bromide (CTAB).
³The curing agent was a dicyandiamide.
^{4a}The coupling agent was γ-(2,3-epoxy propoxy) propyl trimethoxy silane.
^{4b}The coupling agent was γ-aminopropyl triethoxy silane.
^{4c}The coupling agent was Ti(OBu)₄.
⁵The accelerant was 2,4,6-tris (dimethylaminomethyl) phenol.
⁶Samples was heated under high purity nitrogen atmosphere, and the heating rate was 10° C./minute. The listed temperature was the temperature of about 5 wt % weight loss.

### Embodiment 5

### Effect of Curing Agent to Pyrolysis Temperature

In this embodiment, the organic montmorillonite enhanced epoxy resins were prepared by following the process flow in FIG. 2A or 2B. The epoxy resins were crosslinked at room temperature for 24 hours, then at 65° C. for 2 hours. The obtained pyrolysis temperature of each example are listed in Table 5 below. From Table 5, it can be known that the pyrolysis temperatures of organic montmorillonite enhanced epoxy resins were all increased, no matter the kinds of epoxy resins or curing agents.

TABLE 5
Effect of curing agent to pyrolysis temperature.
The listed weight percent of each component was
based on the weight of the epoxy resin.

| | | ²organic | curing | ⁴coupling | |
|---|---|---|---|---|---|
| Exam- | ¹Epoxy | montmorillonite | agent | agent | ⁵accelerant |
| ples | resin | (wt %) | (wt %) | (wt %) | (wt %) |
| 20 | E44 | 0 | ^{3a} 25 | 0 | 317 |
| 21 | E44 | 3 | ^{3a} 25 | 3 | 350 |
| 22 | E44 | 0 | ^{3b} 25 | 0 | 324 |
| 23 | E44 | 3 | ^{3b} 25 | 3 | 358 |
| 24 | E51 | 0 | ^{3a} 25 | 0 | 346 |
| 25 | E51 | 3 | ^{3a} 25 | 3 | 360 |
| 26 | E51 | 0 | ^{3b} 25 | 0 | 345 |
| 27 | E51 | 3 | ^{3b} 25 | 3 | 360 |
| 28 | 6001 | 0 | ^{3a} 25 | 0 | 250 |
| 29 | 6001 | 3 | ^{3a} 25 | 3 | 261 |
| 30 | 6001 | 0 | ^{3b} 25 | 0 | 274 |
| 31 | 6001 | 3 | ^{3b} 25 | 3 | 274 |

¹All epoxy resins used here were bisphenol A glycidyl ether epoxy resins. The epoxy value of both E44 and 6001 was 0.44, and the epoxy resin of E51 was 0.51. The epoxy resin 6001 was added with a flame retarder, Al(OH)₃.
²The intercalation agent of the organic montmorillonite was hexadecyl trimethyl ammonium bromide (CTAB).
^{3a} The curing agent was a product of the addition reaction of diethylenetriamine and epoxypropane butyl ether.
^{3b} The curing agent was phenol sulfonic acid.
⁴The coupling agent was γ-(2,3-epoxy propoxy) propyl trimethoxy silane.
⁵The accelerant was 2,4,6-tris (dimethylaminomethyl) phenol.
⁶ Samples was heated under high purity nitrogen atmosphere, and the heating rate was 10° C./minute. The listed temperature was the temperature of about 5 wt % weight loss.

### Embodiment 6

### Thermal Analysis of Example 10

Since the example 10 had the highest pyrolysis temperature, some thermal analyses were performed for the example 10 and its comparative example, example 11.

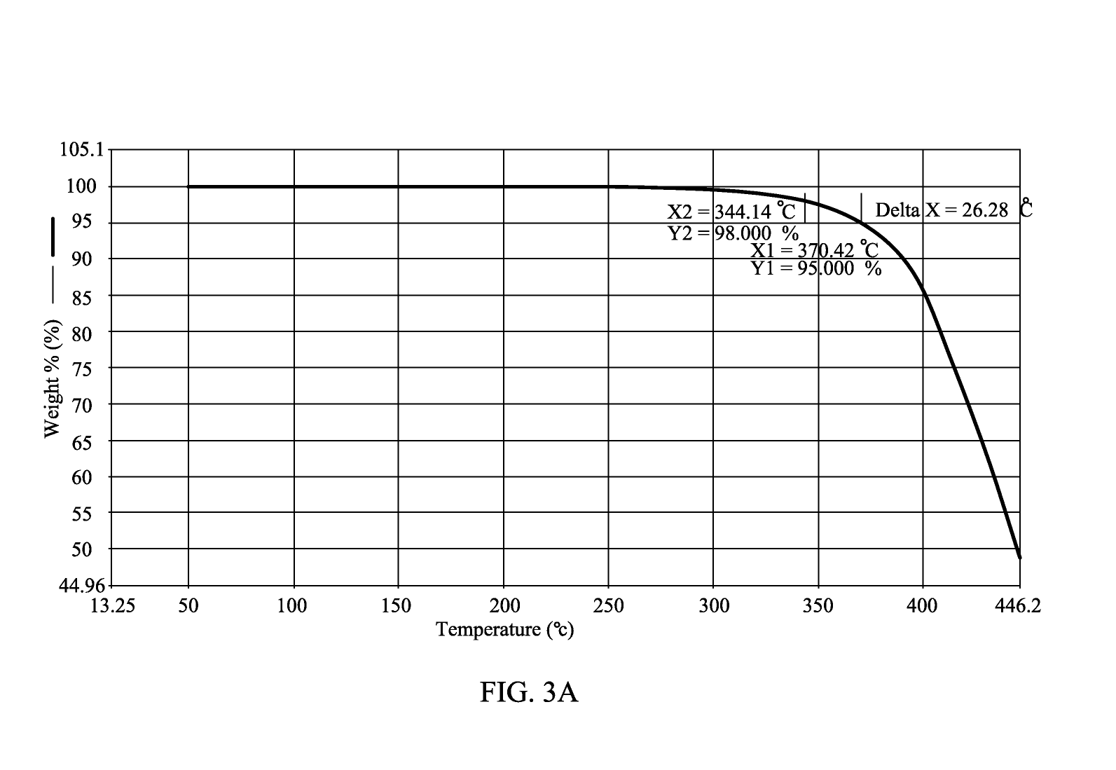

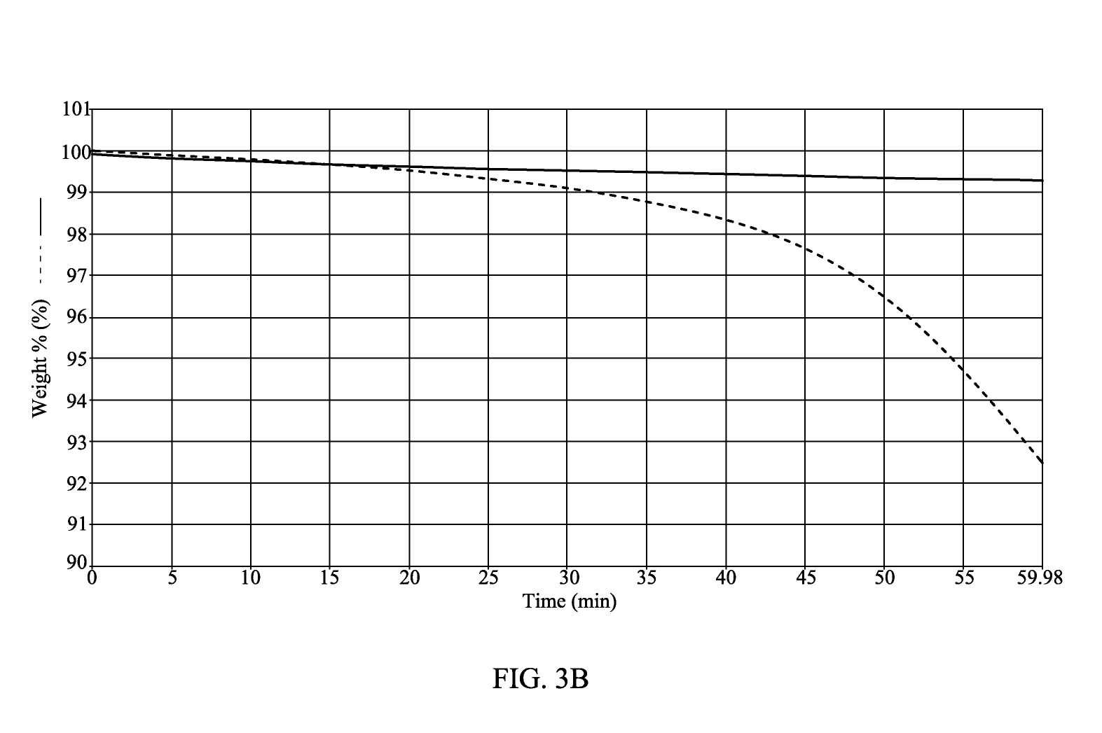

FIG. 3A shows the thermal gravimetric analysis (TGA) curve of example 10. The TGA analysis was performed under a high purity nitrogen atmosphere, and the heating rate was 10° C./minute. From FIG. 3A, it can be seen that the weight loss of example 10 was only 2 wt % at 344.14° C., and only 5 wt % at 370.42° C. This result showed that example 10 has a very high thermal stability.

FIG. 3B shows the TGA curves of example 10 (solid line) and example 11 (dashed line) thermostat at 260° C. for 1 hour. From FIG. 3B, it can be seen that the weight loss of example 10, enhanced by the organic montmorillonite, was only 1 wt %, and the curve was linearly changed. However, the weight loss of example 11, not enhanced by the organic montmorillonite, had been greater than 1 wt % at 260° C. for 32 minutes and greater than 7 wt % at 260° C. for 1 hour. This result showed that the thermal stability of an epoxy resin can be indeed increased by adding the organic montmorillonite, and sever pyrolysis reaction was prevented from occurring.

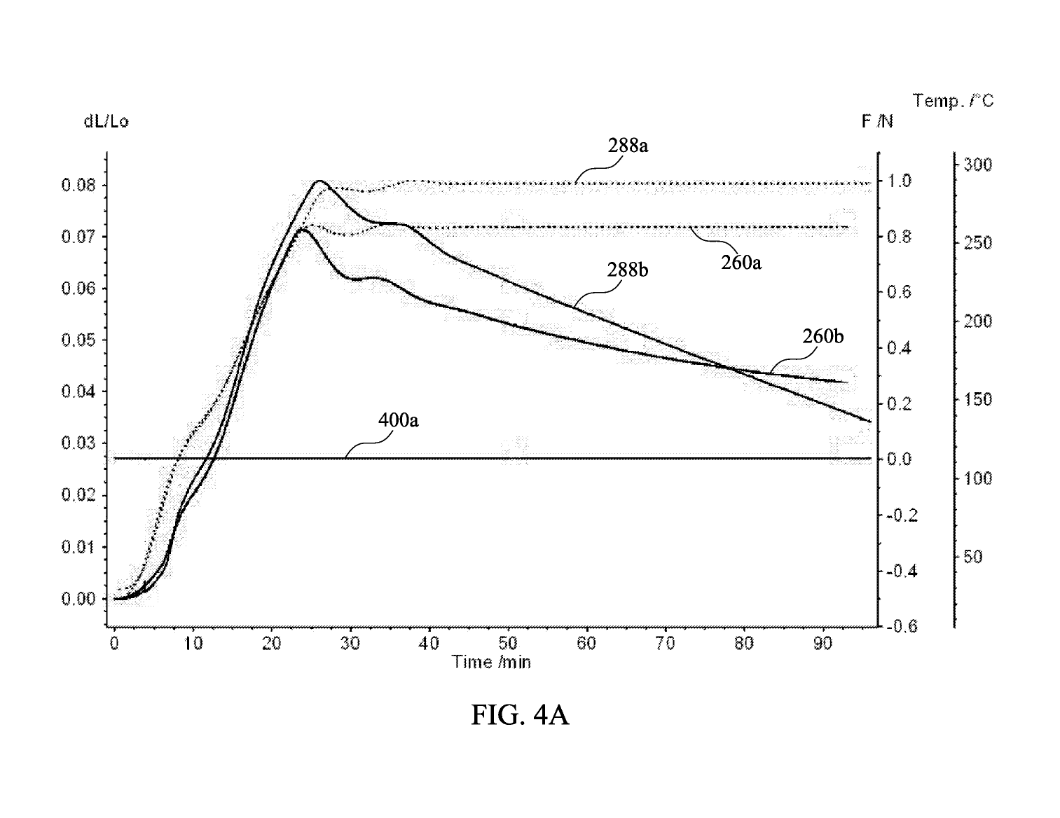

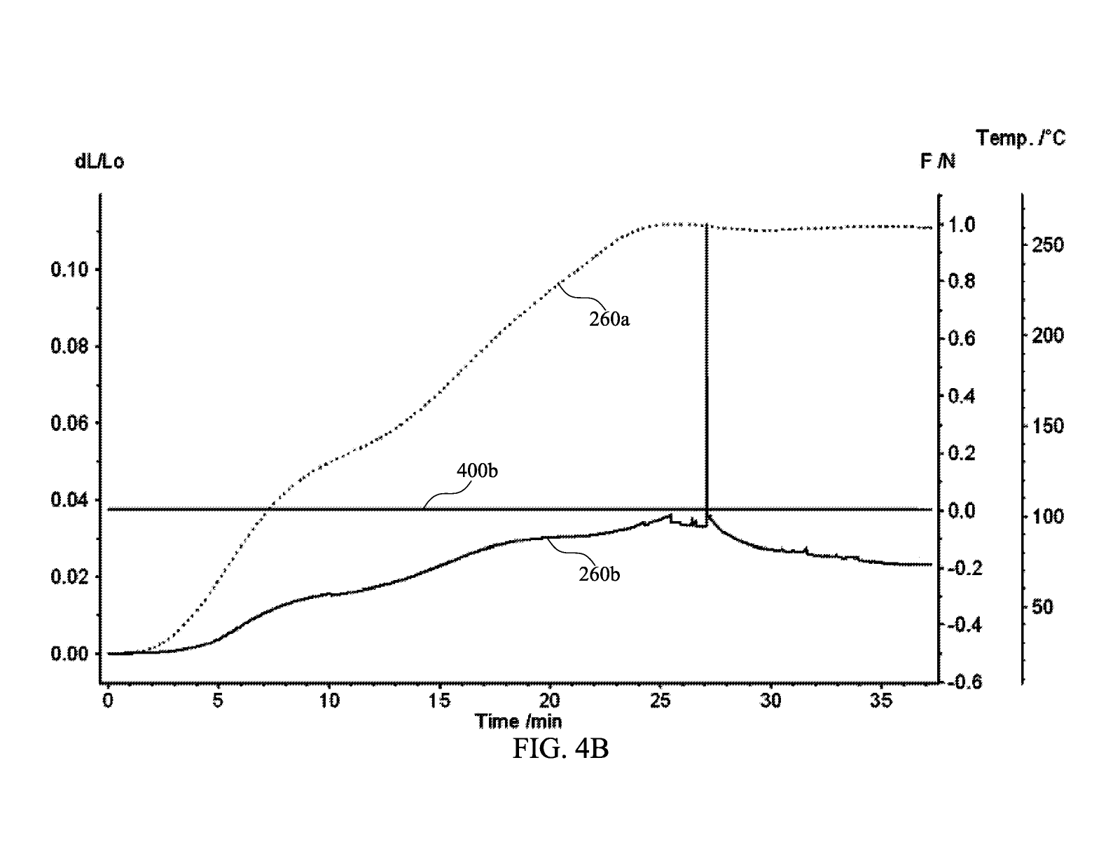

Glass fiber fabrics were respectively impregnated in the organic montmorillonite enhanced epoxy resin solution of example 10 and the epoxy resin solution of the example 11 to form epoxy glass fiber substrates containing 50 wt % of epoxy resin. Then, the epoxy glass fiber substrates of examples 10 and 11 were analyzed by thermomechanical analysis (TMA) to obtain the delamination time at 260° C. and 288° C., respectively. The test environment was filled with high purity of nitrogen, and the heating rate was 10° C./minutes. The obtained results were shown in FIGS. 4A-4B.

FIG. 4A shows TMA curves of the epoxy glass fiber substrates of example 10 respectively at 260° C. and 288° C., and FIG. 4B shows TMA curves of the epoxy glass fiber substrates of example 11 at 260° C. The left vertical axis is the physical quantity of the length change rate dL/L₀ of the sample, and the inner right vertical axis is the physical quantity of the external force F applied by the quartz probe to the sample. The unit of the external force F is Newton (N). The outer right vertical axis is the measured environmental temperature (° C.).

In FIG. 4A, the curve 400a was the external force applied by the quartz probe to a fixed point on the sample during the TMA test process. From the stable curve 400a, it can be known that the force applied by the quartz probe was quite stable. The curves 260a and 288a were the heating curves of the TMA test of 260° C. and 288° C., respectively. The time reaching the temperature of 260° C. or 288° C. was calculated from the intersection of a straight line along the heating curve and the straight line along the heat preservation curve. The curves 260b and the 288b were the length change rate dL/L₀ of the tested epoxy glass fiber substrate. From the curves 260b and 288b, it can be known that the epoxy glass fiber substrate of example 10 did not delamination during the whole TMA test process, since no spikes or step curves were shown. Therefore, the delamination time of the example 10's substrates was longer than 1 hour.

Similarly, in FIG. 4B, the curve 400b was the external force applied by the quartz probe to a fixed point on the sample during the TMA test process. From the stable curve 400b, it can be known that the force applied by the quartz probe was quite stable. The curve 260a was the heating curve of the TMA test of 260° C. Therefore, the time reaching the temperature of 260° C. was calculated from the intersection of a straight line along the heating curve and the straight line along the heat preservation curve. The curve 260b was the length change rate dL/L₀ of the tested epoxy glass fiber substrate. From the curve 260b, it can be known that the delamination time (at the spike) of the example 11's substrate was only 5 minutes after the temperature reached 260° C. Moreover, the example 11's substrate had delaminationed before the temperature reached 288° C. during the TMA test of 288° C. Accordingly, the addition of organic montmorillonite into the epoxy resin can significantly increase the delamination time of the epoxy glass fiber substrate.

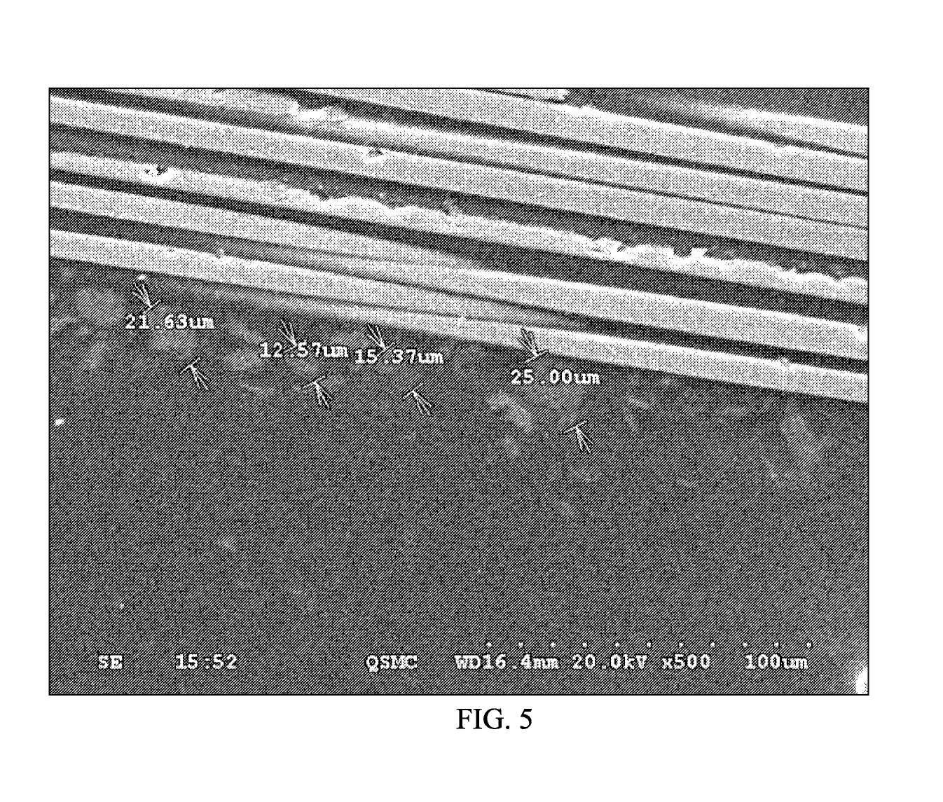

FIG. 5 is a scanning electron microscopic (SEM) photograph of the example 10's substrate stayed at 288° C. for 1 hour. From FIG. 5, it can be known that the layered structure of the example 10's substrate was not obviously changed in the microscopic view. The marked dimensions in FIG. 5 show that the dimensions of the exfolicated organic montmorillonite were between 10-25 μm. Comparing with the original dimension of the organic montmorillonite, it can be known that the organic montmorillonite was effectively exfolicated off to uniformly disperse in the epoxy resin.

Accordingly, the organic montmorillonite enhanced epoxy resin can effectively improve the thermal stability and reliability of the epoxy glass fiber substrate to meet the standards of the unleaded surface-mount technology.

In light of foregoing, a solvent peeling method was used to exfolicate organic montmorillonite. Then, the exfolicated organic montmorillonite was added into an epoxy resin to effectively increase the pyrolysis temperature and thermal stability of the epoxy resin, and thus the thermal stability and the reliability of the latterly obtained epoxy glass fiber substrates of printed circuit boards. Therefore, the epoxy glass fiber substrates can meet the standards of the unleaded surface-mount technology.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A method of preparing an organic montmorillonite enhanced epoxy resin, the method comprising:
preparing a first dispersion solution by dispersing 100 parts by weight of an epoxy resin in a first organic solvent;
preparing a second dispersion solution by dispersing 1-5 parts by weight of an organic montmorillonite in a second organic solvent;
forming a third dispersion solution by sequentially adding 3-9 parts by weight of a curing agent and 1-5 parts by weight of a coupling agent into the second dispersion solution and mixing them uniformly;
forming a fourth dispersion solution by uniformly mixing the first dispersion solution and the third dispersion solution;
forming an epoxy resin mixture by removing the first and the second organic solvents of the fourth dispersion solution; and
forming the organic montmorillonite enhanced epoxy resin by crosslinking the epoxy resin mixture.

2. The method of claim 1, wherein the epoxy resin is bisphenol A glycidyl ether epoxy resin, flame retardant bisphenol A epoxy resin, or polyphenol glycidyl ether epoxy resin.

3. The method of claim 1, wherein the first organic solvent is acetone, dimethyl formamide, toluene, xylene, methyl ethyl ketone, ethanol, butyl glycidyl ether, or any combinations thereof.

4. The method of claim 1, wherein an intercalating agent between inorganic layers of the organic montmorillonite comprises an alkyl trimethyl ammonium bromide, and the alkyl group of the alkyl trimethyl ammonium bromide has 12-18 carbons.

5. The method of claim 1, wherein the second solvent is acetone, dimethyl formamide, toluene, xylene, methyl ethyl ketone, ethanol, butyl glycidyl ether, or any combinations thereof.

6. The method of claim 1, wherein the curing agent is heating type or room temperature type.

7. The method of claim 6, wherein the curing agent of heating type comprises dicyandiamide.

8. The method of claim 6, further comprising adding an accelerant into the second dispersion solution after adding the coupling agent when the curing agent is heating type.

9. The method of claim 8, wherein the accelerant is 2,4,6-tris(dimethylaminomethyl)phenol, or m-phenylenediamine.

10. The method of claim 6, wherein the curing agent of room temperature type comprises a modified amine curing agent.

11. The method of claim 6, wherein the coupling agent is added to the first dispersion solution instead when the curing agent is room temperature type.

12. The method of claim 1, wherein the coupling agent comprises a silane-based coupling agent.

13. The method of claim 12, wherein the silane-based coupling agent is γ-(2,3-epoxy propoxy) propyl trimethoxy silane, γ-aminopropyl triethoxy silane, γ-(methyl-acryloyl oxy) propyl trimethoxy silane, vinyl triethylalkoxy silane, vinyl trimethoxy silane, or vinyl tris(β-methoxyethoxy) silane.

14. An organic montmorillonite enhanced epoxy resin, wherein a preparation composition of the organic montmorillonite enhanced epoxy resin consisting essentially of:
100 parts by weight of an epoxy resin dispersed in a first organic solvent;
1-5 parts by weight of an organic montmorillonite dispersed in a second organic solvent;
3-9 parts by weight of a curing agent added into the second organic solvent; and
1-5 parts by weight of a coupling agent added into the first organic solvent or the second organic solvent.

15. The organic montmorillonite enhanced epoxy resin of claim 14, wherein the epoxy resin comprises bisphenol A glycidyl ether epoxy resin, flame retardant bisphenol A epoxy resin, or polyphenol glycidyl ether epoxy resin.

16. The organic montmorillonite enhanced epoxy resin of claim 14, wherein an intercalating agent between inorganic layers of the organic montmorillonite comprises an alkyl trimethyl ammonium bromide, and the alkyl group of the alkyl trimethyl ammonium bromide has 12-18 carbons.

17. The organic montmorillonite enhanced epoxy resin of claim 14, wherein the curing agent is heating type or room temperature type.

18. The organic montmorillonite enhanced epoxy resin of claim 17, further comprising 0.2-0.6 parts by weight of accelerant added into the second solvent when the curing agent is heating type.

19. The organic montmorillonite enhanced epoxy resin of claim 14, wherein the coupling agent comprises a silane-based coupling agent.

20. The organic montmorillonite enhanced epoxy resin of claim 19, wherein the epoxy resin comprises bisphenol A glycidyl ether epoxy resin, flame retardant bisphenol A epoxy resin, or polyphenol glycidyl ether epoxy resin.
